(19) United States
(12) Patent Application Publication
(10) Pub. No.: US 2025/0358565 A1
(43) Pub. Date: Nov. 20, 2025

(54) SPEAKER AND SPEAKER BOX

(71) Applicant: AAC Microtech (Changzhou) Co., Ltd., Changzhou City (CN)

(72) Inventors: Xin Jin, Changzhou (CN); Wei Song, Changzhou (CN); Yun Tang, Changzhou (CN); Jie Ma, Changzhou (CN)

(21) Appl. No.: 18/988,961

(22) Filed: Dec. 20, 2024

Related U.S. Application Data
(63) Continuation of application No. PCT/CN2024/094213, filed on May 20, 2024.

(51) Int. Cl. H04R 1/28; H04R 1/06; H04R 9/02; H04R 9/06

(52) U.S. Cl. CPC H04R 1/288; H04R 1/06; H04R 9/025; H04R 9/06; H04R 2400/11

(57) ABSTRACT

A speaker and a speaker box are provided. The speaker includes a frame, a vibration system, and a magnetic circuit system. The vibration system is fixed to the frame, the magnetic circuit system is configured to drive the vibration system to vibrate. The magnetic circuit system includes a damping component, an upper clamping plate, a lower clamping plate, and a mounting bracket. A limiting assembly is disposed between the upper clamping plate and the top portion of the damping component. The speaker improves stability of structural installation between the upper clamping plate and the damping component, thereby improving mounting stability and mounting reliability of the magnetic circuit system and avoiding irreversible tearing or impact damage to components, such as the damping component, etc., due to excessive movement of the magnetic circuit system.

### TECHNICAL FIELD

The present disclosure relates to the field of electroacoustics, and in particular to a speaker and a speaker box.

### BACKGROUND

Mobile electronic devices in the related art are more and more functionable with its popularization, and a high-quality music function becomes one of the most common functions in the mobile electronic devices, leading to widespread application of speakers for sound playing in the mobile electronic devices. In the related art, each of the speakers is provided with a damping component, each damping component is respectively connected to a corresponding mounting frame and a magnetic circuit system for enhancing shock resistance, so as to prevent damage to the speakers when the speakers are subjected to strong impacts, thereby improving reliability of both the speakers and the mobile electronic devices. However, the speakers in the related art are poor in stability, when one of the speakers is subjected to impact forces, control over movement of the corresponding magnetic circuit system is inadequate, thereby resulting in irreversible tearing or impact damage to the corresponding damping component and a corresponding voice coil.

Therefore, it is necessary to provide a speaker and a speaker box with better structural stability.

### SUMMARY

The present disclosure aims to provide a speaker and a speaker box, the speaker has excellent overall structural stability, which is capable of performing limitation on movement of a magnetic circuit system when the speaker is subjected to impacts, thereby avoiding irreversible tearing or impact damage to components, such as a damping component, etc., due to excessive movement of the magnetic circuit system.

Technical solutions of the present disclosure are as following.

In a first aspect, the present disclosure provides the speaker, including a frame, a vibration system, and a magnetic circuit system. The vibration system is fixed to the frame, the magnetic circuit system is configured to drive the vibration system to vibrate. The magnetic circuit system includes the damping component, an upper clamping plate, a lower clamping plate, and a mounting bracket, the upper clamping plate and the lower clamping plate are respectively disposed at a top portion of the damping component and a bottom portion of the damping component, and the mounting bracket is connected to an outer side of the damping component. The mounting bracket is fixed to a bottom portion of the frame. A limiting assembly is disposed between the upper clamping plate and the top portion of the damping component.

As an improvement, the damping component includes a first main body and two first side plates, the first main body is disposed perpendicular to a vibration direction, and the two first side plates are respectively disposed at two sides of the first main body along the vibration direction. The mounting bracket includes a second main body and two second side plates, the second main body is disposed perpendicular to the vibration direction, and the two second side plates are respectively disposed at two sides of the second main body along the vibration direction. The two first side plates are disposed corresponding to the two second side plates. The upper clamping plate is connected to top portions of the two first side plates. The limiting assembly includes first protrusions and first concave grooves, the first protrusions are disposed on one surface of the upper clamping plate facing the two first side plates, the first concave grooves are respectively defined on the top portions of the two first side plates and are respectively matched with the first protrusions. The first protrusions respectively extend into the first concave grooves.

As an improvement, the first protrusions are respectively disposed at corner areas of the upper clamping plate. Each of the first concave groves includes a first groove edge and a second groove edge, each first groove edge is matched with an inner side of a corresponding one of the first protrusions, and a corresponding second groove edge is matched with an outer side of the corresponding one of the first protrusions. Each first groove edge extends from a groove bottom of a corresponding one of the first concave grooves to the upper clamping plate. Each second groove edge at least partially extends outward to form a protruding portion protruding out of an outer wall of a corresponding one of the two first side plates, each protruding portion is embedded into a corresponding one of the two second side plates. Second concave grooves are respectively defined on the two second side plates, each of the second concave grooves is matched with a corresponding protruding portion.

As an improvement, a first through hole is defined on a middle area of the first main body, the lower clamping plate is disposed in the first through hole. Two first steps are respectively disposed at edge areas, corresponding to the two first side plates, of a bottom surface of the lower clamping plate, two limiting strips are disposed on the first main body, and the two limiting strips are respectively matched with outer walls of the two first steps. A second through hole is defined on a middle area of the second main body, the first main body is connected to a periphery of the second main body.

As an improvement, second protrusions are respectively disposed on bottom portions of the two first side plates, third concave grooves are respectively defined on bottom portions of the two second side plates, the third concave grooves are respectively matched with the second protrusions.

As an improvement, a third through hole is defined on a middle area of the upper clamping plate. The magnetic circuit system further includes an inner magnetic steel, a pole core, an outer magnetic steel, and a side magnetic steel, the inner magnetic steel is disposed on an area, corresponding to the third through hole, of the lower clamping plate, the pole core is disposed at a top portion of the inner magnetic steel, the outer magnetic steel is disposed at a top portion of the pole core, and the side magnetic steel is disposed between the upper clamping plate and the lower clamping plate. The side magnetic steel is disposed along a circumferential direction of the inner magnetic steel, and a magnetic gap is defined between the side magnetic steel and the inner magnetic steel.

As an improvement, the vibration system includes a middle vibrating diagram, a framework, an upper vibrating diagram, two lower vibrating diagrams, and a voice coil, the middle vibrating diagram is disposed above the outer magnetic steel, the framework is disposed along a periphery of the middle vibrating diagram, the upper vibrating diagram is disposed along a periphery of the framework, the two lower vibrating diagrams are disposed at outer sides of the side magnetic steel, and the voice coil is disposed in the magnetic gap. The upper vibrating diagram is connected to the frame, and the framework is configured to support the middle vibrating diagram and the upper vibrating diagram. The side magnetic steel includes first side magnetic steels and second side magnetic steels, the first side magnetic steels are respectively connected to the two first side plates, each of the second side magnetic steels is vertically disposed at two sides of each of the first side magnetic steels, the two lower vibrating diagrams are respectively disposed at outer sides of the second side magnetic steels.

As an improvement, the speaker further includes two flexible circuit boards (FCBs), the two FCBs are respectively disposed above the two lower vibrating diagrams, the framework is fixed above the two FCBs, the frame is disposed above the two FCBs and is connected to outer sides of the two FCBs. The two FCBs are electrically connected to the voice coil.

As an improvement, the speaker further includes a metal grille disposed outside the mounting bracket and is fixedly connected to the frame.

In a second aspect, the present disclosure provides a speaker box, including a housing having an accommodating space and the speaker as foregoing. The housing includes a first housing body and a second housing body, the first housing body and the second housing body are fixed to each other, and the speaker is accommodated in the accommodating space.

Beneficial effects of the present disclosure are as following.

The present disclosure provides the speaker and the speaker box, the limiting assembly is disposed between the upper clamping plate and the top portion of the damping component to improve stability of structural installation between the upper clamping plate and the damping component, thereby improving mounting stability and mounting reliability of the magnetic circuit system and ensuring that the movement of the magnetic circuit system is limited while the damping component buffers an impact force on the speaker when the speaker is subjected to relatively strong impacts, thereby avoiding the irreversible tearing or the impact damage to the components, such as the damping component, etc., due to the excessive movement of the magnetic circuit system.

### BRIEF DESCRIPTION OF DRAWINGS

FIG. 1 is an overall structural schematic diagram of a speaker box of the present disclosure.

FIG. 2 is an exploded schematic diagram of the speaker box of the present disclosure.

FIG. 3 is an assembly schematic diagram of an upper clamping plate, a mounting bracket, and a damping component.

FIG. 4 is a structural schematic diagram of the damping component.

FIG. 5 is a structural schematic diagram of the mounting bracket.

FIG. 6 is a structural schematic diagram of the upper clamping plate.

FIG. 7 is a structural schematic diagram of a lower clamping plate.

FIG. 8 is a structural schematic diagram of a speaker.

FIG. 9 is a cross-sectional schematic diagram taken along the line A-A shown in FIG. 8.

FIG. 10 is an assembly structural schematic diagram of a metal grille.

### DETAILED DESCRIPTION OF EMBODIMENTS

The present disclosure is further described below with reference to the accompanying drawings and embodiments.

### Embodiment 1

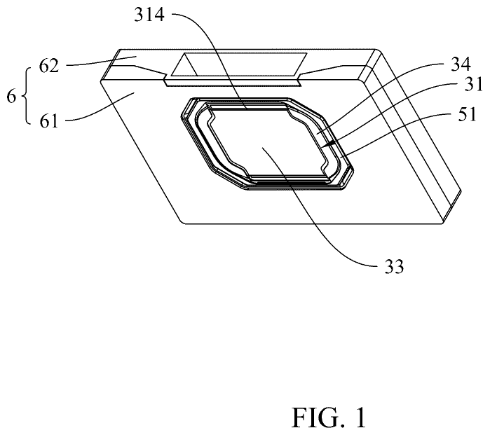

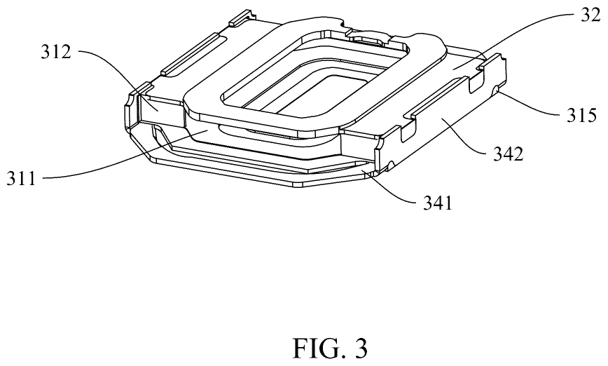

The present disclosure provides a speaker, as shown in FIGS. 1-3, including a frame 1, a vibration system 2, and a magnetic circuit system 3. The vibration system 2 is fixed to the frame 1, the magnetic circuit system 3 is configured to drive the vibration system 2 to vibrate. The magnetic circuit system 3 includes a damping component 31, an upper clamping plate 32, a lower clamping plate 33, and a mounting bracket 34, the upper clamping plate 32 and the lower clamping plate 33 are respectively disposed at a top portion of the damping component 31 and a bottom portion of the damping component 31, and the mounting bracket 34 is connected to an outer side of the damping component 31. The mounting bracket 34 is fixed to a bottom portion of the frame 1. A limiting assembly is disposed between the upper clamping plate 32 and the top portion of the damping component 31. The limiting assembly is disposed between the upper clamping plate 32 and the top portion of the damping component 31 to improve stability of structural installation between the upper clamping plate 32 and the damping component 31, thereby improving mounting stability and mounting reliability of the magnetic circuit system 3 and ensuring that the movement of the magnetic circuit system 3 is limited while the damping component 31 buffers an impact force on the speaker when the speaker is subjected to relatively strong impacts, thereby avoiding the irreversible tearing or the impact damage to the components, such as the damping component 31, etc., due to excessive movement of the magnetic circuit system 3.

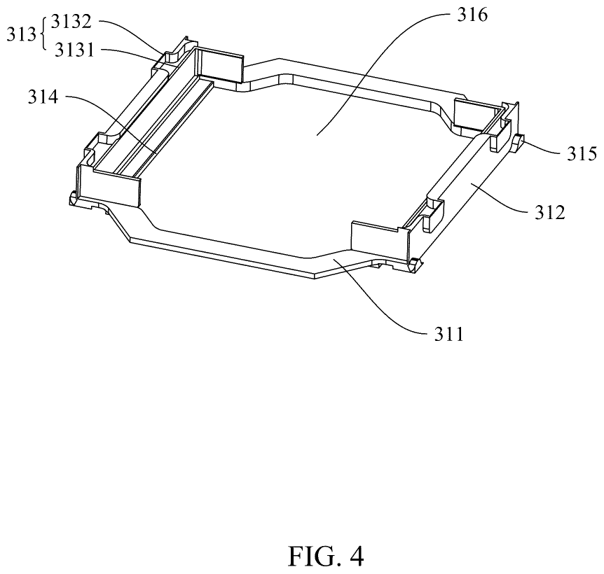

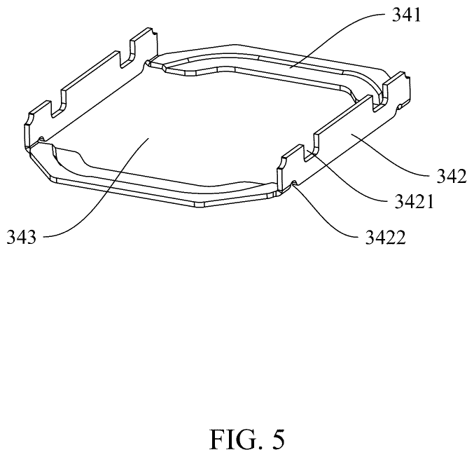

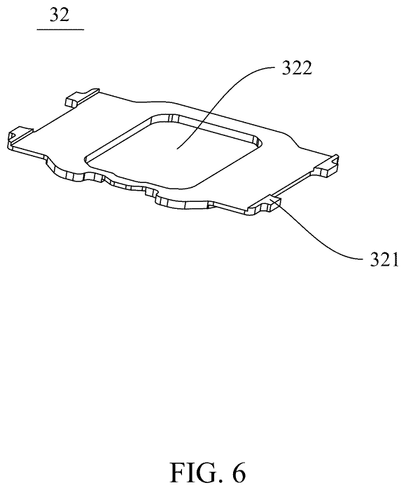

As shown in FIG. 4, the damping component 31 includes a first main body 311 and two first side plates 312, the first main body 311 is disposed perpendicular to a vibration direction, and the two first side plates 312 are respectively disposed at two sides of the first main body 311 along the vibration direction. As shown in FIG. 5, the mounting bracket 34 includes a second main body 341 and two second side plates 342, the second main body 341 is disposed perpendicular to the vibration direction, and the two second side plates 342 are respectively disposed at two sides of the second main body 341 along the vibration direction. The two first side plates 312 are disposed corresponding to the two second side plates 342. The upper clamping plate 32 is connected to top portions of the two first side plates 312. As shown in FIG. 6, the limiting assembly includes first protrusions 321 and first concave grooves 313, the first protrusions 321 are disposed on one surface of the upper clamping plate 32 facing the two first side plates 312, the first concave grooves 313 are respectively defined on the top portions of the two first side plates 312 and are respectively matched with the first protrusions 321. The first protrusions 321 respectively extend into the first concave grooves 313. Specifically, the upper clamping plate 32 and the two first side plates 312 are limited through cooperation between the first protrusions 321 and the first concave grooves 313, thereby improving connection stability between the upper clamping plate 32 and the damping component 31.

Furthermore, the first protrusions 321 are respectively disposed at corner areas of the upper clamping plate 32. Each of the first concave groves 313 includes a first groove edge 3131 and a second groove edge 3132, each first groove edge 3131 is matched with an inner side of a corresponding one of the first protrusions 321, and a corresponding second groove edge 3132 is matched with an outer side of the corresponding one of the first protrusions 321. Each first groove edge 3131 extends from a groove bottom of a corresponding one of the first concave grooves 313 to the upper clamping plate 32. Each second groove edge 3132 at least partially extends outward to form a protruding portion protruding out of an outer wall of a corresponding one of the two first side plates 312, each protruding portion is embedded into a corresponding one of the two second side plates 342. Second concave grooves 3421 are respectively defined on the two second side plates 342, each of the second concave grooves 3421 is matched with a corresponding protruding portion. The first protrusions 321 are respectively limited in the first concave grooves 313 through cooperation between each first groove edge 3131 and the corresponding second groove edge 3132, thereby limiting the upper clamping plate 32. As an improvement, each first groove edge 3131 extends upward from the groove bottom of the corresponding one of the first concave grooves 313 to be in contact with a bottom surface of the upper clamping plate 32.

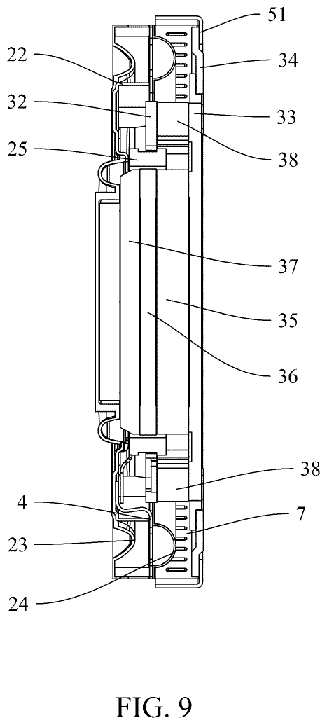

A first through hole 316 is defined on a middle area of the first main body 311, the lower clamping plate 33 is disposed in the first through hole 316. As shown in FIG. 9, two first steps 311 are respectively disposed at edge areas, corresponding to the two first side plates 312, of a bottom surface of the lower clamping plate 33, two limiting strips 314 are disposed on the damping component 31, and the two limiting strips 314 are respectively matched with outer walls of the two first steps 331. A second through hole 343 is defined on a middle area of the second main body 341, the first main body 311 is connected to a periphery of the second main body 341.

Second protrusions 315 are respectively disposed on bottom portions of the two first side plates 312, third concave grooves 3422 are respectively defined on bottom portions of the two second side plates 342, the third concave grooves 3422 are respectively matched with the second protrusions 315. Mutual cooperation between the second protrusions 315 and the third concave grooves 3422 improves connection stability between the two first side plates 312 and the two second side plates 342.

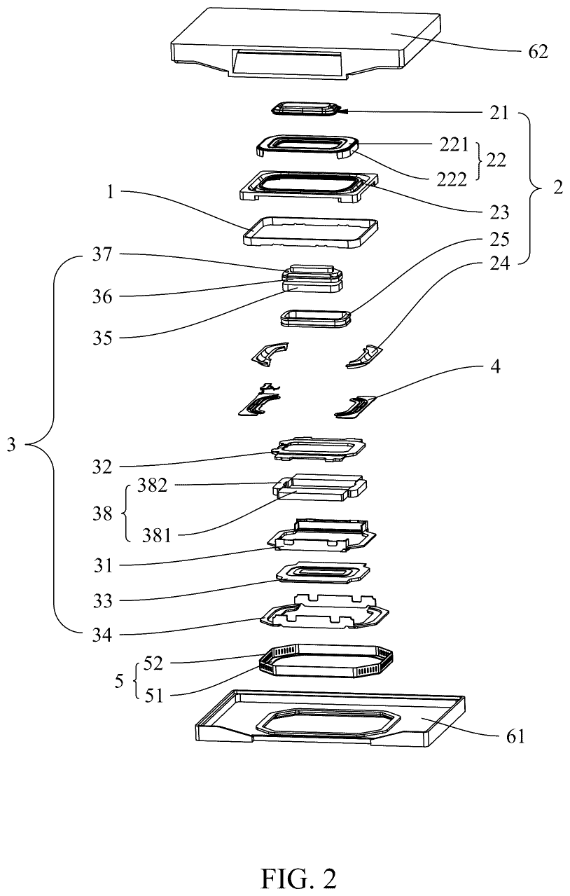

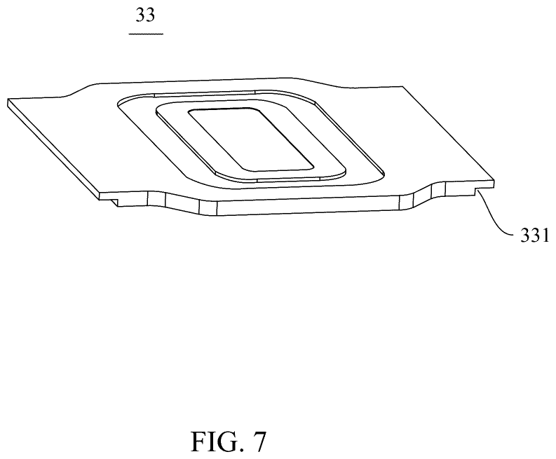

As shown in FIGS. 2-9, a third through hole 322 is defined on a middle area of the upper clamping plate 32. The magnetic circuit system 3 further includes an inner magnetic steel 35, a pole core 36, an outer magnetic steel 37, and a side magnetic steel 38, the inner magnetic steel 35 is disposed on an area, corresponding to the third through hole 322, of the lower clamping plate 33, the pole core 36 is disposed at a top portion of the inner magnetic steel 35, the outer magnetic steel 37 is disposed at a top portion of the pole core 36, and the side magnetic steel 38 is disposed between the upper clamping plate 32 and the lower clamping plate 33. The side magnetic steel 38 is disposed along a circumferential direction of the inner magnetic steel 35, and a magnetic gap is defined between the side magnetic steel 38 and the inner magnetic steel 35.

The vibration system 2 includes a middle vibrating diagram 21, a framework 22, an upper vibrating diagram 23, two lower vibrating diagrams 24, and a voice coil 25. The middle vibrating diagram 21 is disposed above the outer magnetic steel 37, the framework 22 is disposed along a periphery of the middle vibrating diagram 21, the upper vibrating diagram 23 is disposed along a periphery of the framework 22, the two lower vibrating diagrams 24 are disposed at outer sides of the side magnetic steel 38, and the voice coil 25 is disposed in the magnetic gap. The upper vibrating diagram 23 is connected to the frame 1, and the framework 22 is configured to support the middle vibrating diagram 21 and the upper vibrating diagram 23. The side magnetic steel 38 includes first side magnetic steels 381 and second side magnetic steels 382, the first side magnetic steels 381 are respectively connected to the two first side plates 312, each of the second side magnetic steels 382 is vertically disposed at two sides of each of the first side magnetic steels 381, the two lower vibrating diagrams 24 are respectively disposed at outer sides of the second side magnetic steels 382.

The speaker further includes two flexible circuit boards (FCBs) 4, the two FCBs 4 are respectively disposed above the two lower vibrating diagrams 24, the framework 22 is fixed above the two FCBs 4, the frame 1 is disposed above the two FCBs 4 and is connected to outer sides of the two FCBs 4. The two FCBs 4 are electrically connected to the voice coil 25.

The framework 22 includes a third main body 22 and two third side plates 222, the third main body 221 is perpendicular to the vibration direction, the two third side plates 222 are disposed on a bottom surface of the third main body 221 along the vibration direction, and the framework 22 is fixedly connected to the two PCBs 4 through the two third side plates 222. In use, the two PCBs 4 convert an input external electrical signal into a current for driving the voice coil 25, and the current drives the voice coil 25 to drive the upper vibrating diaphragm 23 and the two lower vibrating diaphragms 24 to vibrate.

The speaker further includes a metal grille 5 disposed outside the mounting bracket 34 and is fixedly connected to the frame 1.

The present disclosure further provides a speaker box, including a housing 6 having an accommodating space and the speaker as foregoing. The housing 6 includes a first housing body 61 and a second housing body 62, the first housing body 61 and the second housing body 62 are fixed to each other, and the speaker is accommodated in the accommodating space.

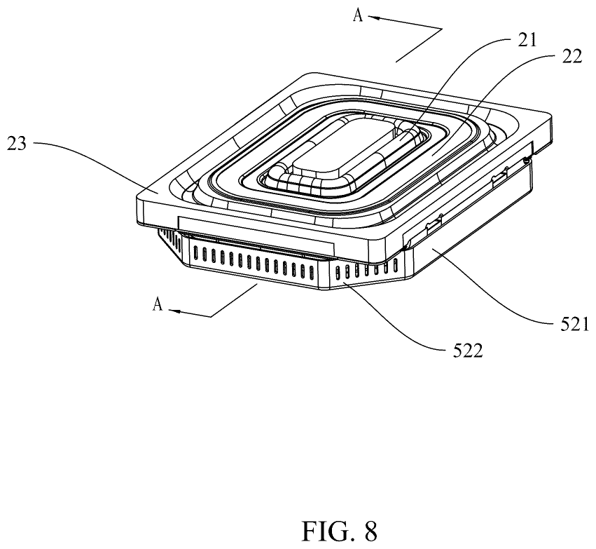

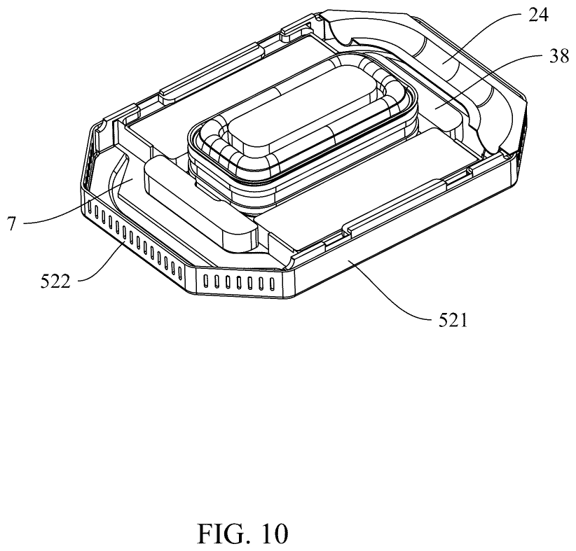

Furthermore, as shown in FIGS. 8-10, the metal grille 5 includes a fourth main body 51 and a fourth side plate 52, the fourth main body is disposed on one surface of the mounting bracket 34 away from the upper clamping plate 32, the fourth side plate 52 is disposed at a periphery of the fourth main body 51, the fourth side plate 51 includes two first segments 521 and two second segments 522, the two first segments 521 are respectively connected to outer sides of the two second side plates 342, the two second segments 522 are connected between the two first segments 521. Two gaps 7 are respectively defined between the side magnetic steel 38 and the two second segments 522, the two lower vibrating diagrams 24 are recessed downward to respectively extend into the gaps 7.

The foregoing are merely embodiments of the present disclosure, and it should be noted that, for those who skilled in the art, improvements can be made without departing from the concepts of the present disclosure, but these are all within the protection scopes of the present disclosure.

What is claimed is:

1. A speaker, comprising:
a frame;
a vibration system; and
a magnetic circuit system;
wherein the vibration system is fixed to the frame, the magnetic circuit system is configured to drive the vibration system to vibrate;
the magnetic circuit system comprises a damping component, an upper clamping plate, a lower clamping plate, and a mounting bracket, the upper clamping plate and the lower clamping plate are respectively disposed at a top portion of the damping component and a bottom portion of the damping component, and the mounting bracket is connected to an outer side of the damping component;
the mounting bracket is fixed to a bottom portion of the frame; and
a limiting assembly is disposed between the upper clamping plate and the top portion of the damping component.

2. The speaker according to claim 1, wherein the damping component comprises a first main body and two first side plates, the first main body is disposed perpendicular to a vibration direction, and the two first side plates are respectively disposed at two sides of the first main body along the vibration direction;
the mounting bracket comprises a second main body and two second side plates, the second main body is disposed perpendicular to the vibration direction, and the two second side plates are respectively disposed at two sides of the second main body along the vibration direction;
the two first side plates are disposed corresponding to the two second side plates;
the upper clamping plate is connected to top portions of the two first side plates; and
the limiting assembly comprises first protrusions and first concave grooves, the first protrusions are disposed on one surface of the upper clamping plate facing the two first side plates, the first concave grooves are respectively defined on the top portions of the two first side plates and are respectively matched with the first protrusions; and
the first protrusions respectively extend into the first concave grooves.

3. The speaker according to claim 2, wherein the first protrusions are respectively disposed at corner areas of the upper clamping plate;
each of the first concave groves comprises a first groove edge and a second groove edge, each first groove edge is matched with an inner side of a corresponding one of the first protrusions, and a corresponding second groove edge is matched with an outer side of the corresponding one of the first protrusions;
each first groove edge extends from a groove bottom of a corresponding one of the first concave grooves to the upper clamping plate; and
each second groove edge at least partially extends outward to form a protruding portion protruding out of an outer wall of a corresponding one of the two first side plates, each protruding portion is embedded into a corresponding one of the two second side plates; and
second concave grooves are respectively defined on the two second side plates, each of the second concave grooves is matched with a corresponding protruding portion.

4. The speaker according to claim 2, wherein a first through hole is defined on a middle area of the first main body, the lower clamping plate is disposed in the first through hole;
two first steps are respectively disposed at edge areas, corresponding to the two first side plates, of a bottom surface of the lower clamping plate, two limiting strips are disposed on the first main body, and the two limiting strips are respectively matched with outer walls of the two first steps; and
a second through hole is defined on a middle area of the second main body, the first main body is connected to a periphery of the second main body.

5. The speaker according to claim 2, wherein second protrusions are respectively disposed on bottom portions of the two first side plates, third concave grooves are respectively defined on bottom portions of the two second side plates, the third concave grooves are respectively matched with the second protrusions.

6. The speaker according to claim 2, wherein a third through hole is defined on a middle area of the upper clamping plate;
the magnetic circuit system further comprises an inner magnetic steel, a pole core, an outer magnetic steel, and a side magnetic steel, the inner magnetic steel is disposed on an area, corresponding to the third through hole, of the lower clamping plate, the pole core is disposed at a top portion of the inner magnetic steel, the outer magnetic steel is disposed at a top portion of the pole core, and the side magnetic steel is disposed between the upper clamping plate and the lower clamping plate; and
the side magnetic steel is disposed along a circumferential direction of the inner magnetic steel, and a magnetic gap is defined between the side magnetic steel and the inner magnetic steel.

7. The speaker according to claim 6, wherein the vibration system comprises a middle vibrating diagram, a framework, an upper vibrating diagram, two lower vibrating diagrams, and a voice coil, the middle vibrating diagram is disposed above the outer magnetic steel, the framework is disposed along a periphery of the middle vibrating diagram, the upper vibrating diagram is disposed along a periphery of the framework, the two lower vibrating diagrams are disposed at outer sides of the side magnetic steel, and the voice coil is disposed in the magnetic gap;
the upper vibrating diagram is connected to the frame, and the framework is configured to support the middle vibrating diagram and the upper vibrating diagram; and
the side magnetic steel comprises first side magnetic steels and second side magnetic steels, the first side magnetic steels are respectively connected to the two first side plates, each of the second side magnetic steels is vertically disposed at two sides of each of the first side magnetic steels, the two lower vibrating diagrams are respectively disposed at outer sides of the second side magnetic steels.

8. The speaker according to claim 7, wherein the speaker further comprises two flexible circuit boards (FCBs), the two FCBs are respectively disposed above the two lower vibrating diagrams, the framework is fixed above the two FCBs, the frame is disposed above the two FCBs and is connected to outer sides of the two FCBs; and
the two FCBs are electrically connected to the voice coil.

9. The speaker according to claim 1, wherein the speaker further comprises a metal grille disposed outside the mounting bracket and is fixedly connected to the frame.

10. A speaker box, comprising:
a housing, having an accommodating space; and
the speaker according to claim 1;
wherein the housing comprises a first housing body and a second housing body, the first housing body and the second housing body are fixed to each other, and the speaker is accommodated in the accommodating space.
